(19) United States
(12) Patent Application Publication
(10) Pub. No.: US 2026/0180295 A1
(43) Pub. Date: Jun. 25, 2026

(54) ELECTRICAL INTELLIGENT CONCEALED BOX STRUCTURE DEVICE

(71) Applicant: NANJING IOT SENSOR TECHNOLOGY CO., LTD (GUANGZHOU), Guangzhou (CN)

(72) Inventors: Xi CAO, Guangzhou (CN); Xinbin SU, Guangzhou (CN); Feng ZHU, Guangzhou (CN); Junling ZHU, Guangzhou (CN); Jianmei YU, Guangzhou (CN); Mingcheng WU, Guangzhou (CN); Zhifu ZHOU, Guangzhou (CN)

(21) Appl. No.: 18/843,281

(22) PCT Filed: Jul. 21, 2023
(86) PCT No.: PCT/CN2023/108553

§ 371 Date: Sep. 2, 2024

(30) Foreign Application Priority Data
Apr. 21, 2023 (CN) 202310434556.0

(51) Int. Cl. H02G 3/08

(52) U.S. Cl. CPC H02G 3/081

(57) ABSTRACT

The present disclosure discloses an electrical intelligent concealed box structure device, including an electrical product assembly and a concealed box assembly which are clamped with each other; a safety door and an elastic sheet are arranged in sequence in the concealed box assembly and close to the electrical product assembly; and the electrical product assembly is driven to be inserted into the elastic sheet to drive the electrical product assembly to keep being electrically connected to the concealed box assembly. According to the electrical intelligent concealed box structure device provided in the present disclosure, the safety door in an initial state covers the elastic sheet through reset springs to protect the elastic sheet. After an insertion sheet is inserted, the safety door can slide along a wiring frame along the inclined safety door and the reset springs on two sides, so as to expose the elastic sheet, and the insertion sheet is conveniently inserted into the elastic sheet. The elastic sheet and the safety door can be accommodated in the concealed box through separation slots of concealed box inside a concealed box bottom cover, and powering on can be achieved after the electrical product assembly is plugged. When the electrical product assembly needs to be replaced, only a product shell needs to be separated from the concealed box assembly to achieve quick replacement.

### TECHNICAL FIELD

The present disclosure relates to the technical field of electrical products, and in particular, to an electrical intelligent concealed box structure device.

### BACKGROUND

With the development of the smart home industry, the trend of intelligence of electrical products such as switches and sockets is obvious, and the market share is increasingly high. Compared with a traditional mechanical product, intelligent products have a high damage rate. This brings inconvenience and cost of product maintenance to ordinary users.

For example, patent CN112670754A discloses a mounting structure for an intelligent socket panel and a concealed box, with a function of preventing entry of condensed water, including a socket panel body and a concealed box. A decorative frame sleeves a front end of the socket panel box; the concealed box is configured to be pre-buried in a wall; screw holes are arranged at four corners of the socket panel body; the screw holes are configured to allow screws to pass through to fix the socket panel body on the concealed box; a threaded hole is provided at each corner of the concealed box; the threaded holes are configured to be in threaded connection with the screws arranged in the screw holes in a penetrating manner; a rubber ring is embedded on a front end surface of the concealed box; the rubber ring is located on inner sides of all the threaded holes; and an inwards contraction section is arranged on the rubber ring located at each threaded hole. This invention can prevent the condensed water from entering the concealed box from a gap between the socket panel body and the concealed box, thereby avoiding short circuits or electric leakage in the socket panel body and eliminating the potential safety hazards.

In an actual operation process, because most traditional electrical products cannot be disassembled, they can only be overall replaced after their appearances are damaged. In the replacement process, there is a risk of electric leakage, and parts are wasted.

It can be seen that the above-mentioned problems in the existing technology urgently need to be improved.

### SUMMARY

In view of the above problems in the existing technology, one objective of the present disclosure is to provide an electrical intelligent concealed box structure device, to solve the following problems: A connection port of a traditional electrical product cannot be removed if it is damaged, and the entire traditional electrical product needs to be replaced, which easily causes waste; and there is a risk of electric leakage in a replacement process.

To achieve the above objectives, the present disclosure provides an electrical intelligent concealed box structure device, including an electrical product assembly and a concealed box assembly which are clamped with each other; a safety door and an elastic sheet are arranged in sequence in the concealed box assembly and close to the electrical product assembly; and the electrical product assembly is driven to be inserted into the elastic sheet to drive the electrical product assembly to keep being electrically connected to the concealed box assembly.

As a preference, the concealed box assembly includes a concealed box shell; a concealed box inner slot is formed inside the concealed box shell; and various insertion sheet slots are formed in the concealed box inner slot to drive the electrical product assembly to be plugged into the concealed box assembly.

As a preference, several inclined rails are arranged in the safety door; and various output ends of the inclined rails are aligned with the inside of the elastic sheet, so that the electrical product assembly is driven to be inserted into the elastic sheet.

As a preference, a wiring frame sleeves a top of the elastic sheet; and an outer wall of one side of the wiring frame away from the safety door is clamped with several fixing screws to drive the safety door to keep being connected and fixed with the elastic sheet.

As a preference, reset springs are arranged at end portions of two opposite sides of the safety door; and the reset springs are configured to drive the safety door to keep sliding back and forth along the elastic sheet, so as to drive the elastic sheet to be exposed.

By the arrangement of the reset springs, the safety door in an initial state covers the elastic sheet to protect the elastic sheet. After an insertion sheet is inserted, the safety door can slide along a wiring frame along the inclined safety door and the reset springs on the two sides, so as to expose the elastic sheet, and the insertion sheet is conveniently inserted into the elastic sheet.

As a preference, the concealed box assembly includes a concealed box bottom cover; several separation slots of concealed box are formed in the concealed box bottom cover to clamp the various fixing screws; and the concealed box bottom cover is driven to be clamped to an outer wall of the concealed box inner slot, so as to drive the elastic sheet and the safety door to be accommodated in the concealed box shell.

To protect the elastic sheet and the safety door, the elastic sheet and the safety door can be accommodated in the concealed box through the separation slots of concealed box inside the concealed box bottom cover, and powering on can be achieved after the electrical product assembly is plugged. When the electrical product assembly needs to be replaced, only a product shell needs to be separated from the concealed box assembly to achieve quick replacement.

As a preference, the electrical product assembly includes a product shell; several insertion sheets are arranged in the product shell; and the insertion sheets keep being electrically connected to the elastic sheet.

### BENEFICIAL EFFECTS

Compared with the prior art, the present disclosure provides an electrical intelligent concealed box structure device, which has the following beneficial effects:
1. By the arrangement of the reset springs, the safety door in an initial state covers the elastic sheet to protect the elastic sheet. After an insertion sheet is inserted, the safety door can slide along a wiring frame along the inclined safety door and the reset springs on the two sides, so as to expose the elastic sheet, and the insertion sheet is conveniently inserted into the elastic sheet.
2. To protect the elastic sheet and the safety door, the elastic sheet and the safety door can be accommodated in the concealed box through the separation slots of concealed box inside the concealed box bottom cover, and powering on can be achieved after the electrical product assembly is plugged. When the electrical product assembly needs to be replaced, only a product shell needs to be separated from the concealed box assembly to achieve quick replacement.

### BRIEF DESCRIPTION OF THE DRAWINGS

To describe the technical solutions in the embodiments of the present disclosure or in the prior art more clearly, the following will briefly introduce the accompanying drawings needing to be used in the embodiments. Apparently, the accompanying drawings in the following description show merely some embodiments of the present disclosure, and a person of ordinary skill in the art may still derive other drawings from the accompanying drawings.

FIG. 1 is a schematic structural diagram of a front surface of an electrical intelligent concealed box structure according to an embodiment of the present disclosure;

FIG. 2 is a schematic structural diagram of a concealed box shell according to an embodiment of the present disclosure;

FIG. 3 is a schematic structural diagram of an exploded diagram of a concealed box assembly according to an implementation of the present disclosure; and

FIG. 4 is a schematic structural diagram of an exploded diagram of a concealed box assembly according to an implementation of the present disclosure.

### MAIN REFERENCE NUMERALS IN THE ACCOMPANYING DRAWINGS

1: electrical product assembly; 2: concealed box assembly; 101: product shell; 102: insertion sheet; 201: concealed box shell; 202: concealed box inner slot; 203: insertion sheet slot; 204: safety door; 205: reset spring; 206: wiring frame; 207: concealed box bottom cover; 208: separation slot of concealed box; 209: fixing screw; and 210: elastic sheet.

### DETAILED DESCRIPTION OF THE EMBODIMENTS

To make a person skilled in the art better understand the technical solutions of the present disclosure, the present disclosure will be further explained in detail below in conjunction with the accompanying drawings.

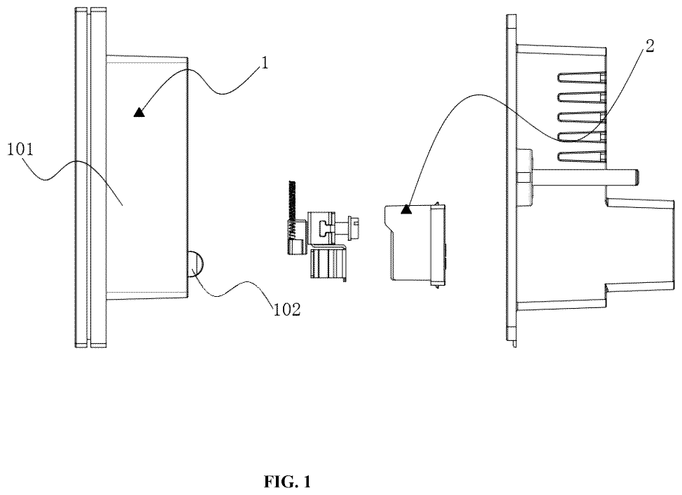

As shown in FIG. 1 to FIG. 4, an electrical intelligent concealed box structure device includes an electrical product assembly 1 and a concealed box assembly 2 which are clamped with each other; a safety door 204 and an elastic sheet 210 are arranged in sequence in the concealed box assembly 2 and close to the electrical product assembly 1; and the electrical product assembly 1 is driven to be inserted into the elastic sheet 210 to drive the electrical product assembly 1 to keep being electrically connected to the concealed box assembly 2.

The electrical intelligent concealed box structure device mainly aims to enable the safety door 204 in an initial state to cover the elastic sheet 210 through reset springs 205 to protect the elastic sheet 210. After an insertion sheet 102 is inserted, the safety door 204 can slide along a wiring frame 206 along the inclined safety door 204 and the reset springs 205 on two sides, so as to expose the elastic sheet 210, and the insertion sheet 102 is conveniently inserted into the elastic sheet 210. To protect the elastic sheet 210 and the safety door 204, they can be accommodated in the concealed box through separation slots 208 of concealed box inside a concealed box bottom cover 207, and powering on can be achieved after the electrical product assembly 1 is plugged. When the electrical product assembly 1 needs to be replaced, only a product shell 101 needs to be separated from the concealed box assembly 2 to achieve quick replacement.

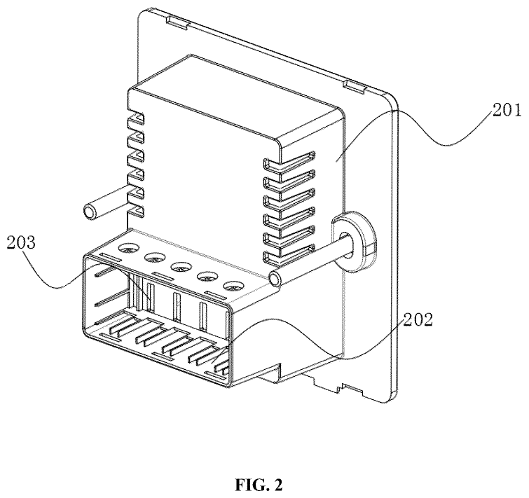

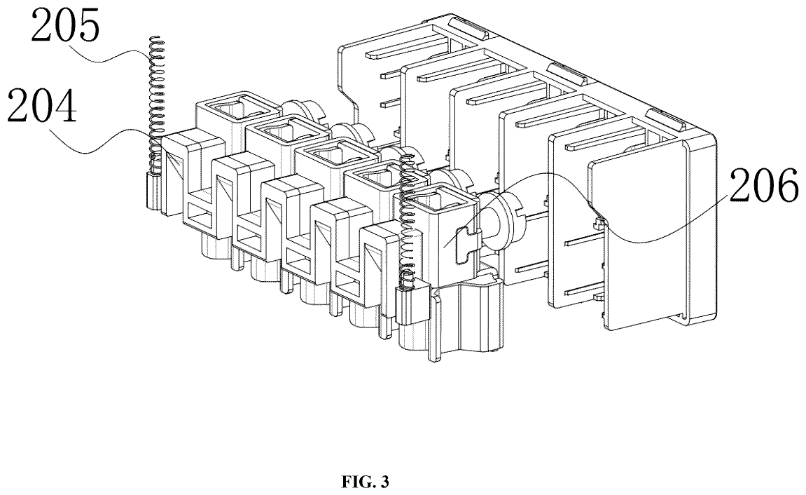

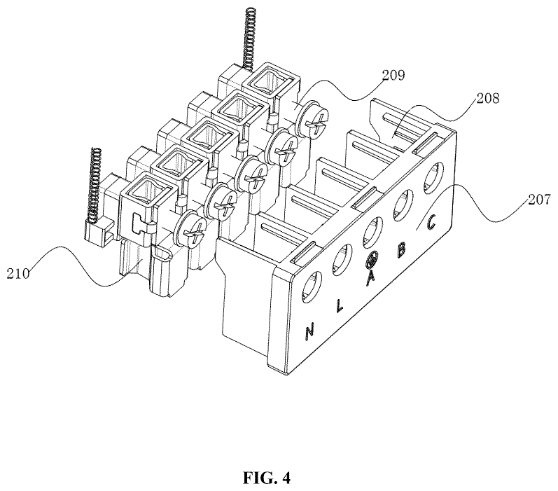

In the technical solutions provided in the present disclosure, it can be seen from FIG. 1, FIG. 2, FIG. 3, and FIG. 4, the concealed box assembly 2 includes a concealed box shell 201; a concealed box inner slot 202 is formed inside the concealed box shell 201; and various insertion sheet slots 203 are formed in the concealed box inner slot 202 to drive the electrical product assembly 1 to be plugged into the concealed box assembly 2.

Furthermore, several inclined rails are arranged in the safety door 204, so that after the electrical product assembly 1 is plugged, an upward force is generated to drive the safety door 204 to slide to expose the elastic sheet 210, and the electrical product assembly 1 is plugged into the elastic sheet 210.

Moreover, a wiring frame 206 sleeves a top of the elastic sheet 210; and an outer wall of one side of the wiring frame 206 away from the safety door 204 is clamped with several fixing screws 209 to drive the safety door 204 to keep being connected and fixed with the elastic sheet 210.

Further, reset springs 205 are arranged at end portions of two opposite sides of the safety door 204; and the reset springs 205 are configured to drive the safety door 204 to keep sliding back and forth along the wiring frame 206. When the electrical product assembly 1 is plugged to an outer wall of the safety door 204, the safety door 204 can generate the upward force through the inclined rails to expose the elastic sheet 210, and the electrical product assembly 1 is plugged into the elastic sheet 210.

Further, the concealed box assembly 2 includes a concealed box bottom cover 207; several separation slots 208 of concealed box are formed in the concealed box bottom cover 207 to clamp the various fixing screws 209; and the concealed box bottom cover 207 can be clamped to an outer wall of the concealed box inner slot 202, so as to accommodate the elastic sheet 210 and the safety door 204 in the concealed box shell 201 for protection, thus making a whole.

In the technical solutions provided in the present disclosure, it can be seen from FIG. 1 that the electrical product assembly 1 includes a product shell 101; several insertion sheets 102 are further arranged in the product shell 101; and the insertion sheets 102 can be electrically connected into the elastic sheet 210.

Working principle: First, if the electrical product assembly 1 is damaged, only the product shell 101 and the concealed box assembly 2 are separated, including but not limited to clamping, magnetic suction, and the like. The insertion sheets 102 are removed from the elastic sheet 210.

An undamaged electrical product assembly 1 is then used. The various insertion sheets 102 are inserted from the insertion sheet slots 203 and resist against the outer wall of the safety door 204.

Then, the safety door 204 can slide along the wiring frame 206 through the inclined rails in the safety door 204 and the reset springs 205 arranged on the outer wall, so that the elastic sheet 210 is exposed, and the insertion sheets 102 can be inserted into the elastic sheet 210 for electrical connection.

The above only describes some exemplary embodiments of the present disclosure through explanation. Undoubtedly, a person of ordinary skill in the art can modify the described embodiments in various ways without deviating from the spirit and scope of the present disclosure. Therefore, the above accompanying drawings and descriptions are essentially explanatory and should not be understood as limiting the scope of protection of the claims of the present disclosure.

What is claimed is:

1. An electrical intelligent concealed box structure device, comprising an electrical product assembly (1) and a concealed box assembly (2) which are clamped with each other, wherein a safety door (204) and an elastic sheet (210) are arranged in sequence in the concealed box assembly (2) and close to the electrical product assembly (1); and the electrical product assembly (1) is driven to be inserted into the elastic sheet (210) to drive the electrical product assembly (1) to keep being electrically connected to the concealed box assembly (2).

2. The electrical intelligent concealed box structure device according to claim 1, wherein the concealed box assembly (2) comprises a concealed box shell (201); a concealed box inner slot (202) is formed inside the concealed box shell (201); and various insertion sheet slots (203) are formed in the concealed box inner slot (202) to drive the electrical product assembly (1) to be plugged into the concealed box assembly (2).

3. The electrical intelligent concealed box structure device according to claim 1, wherein several inclined rails are arranged in the safety door (204); and various output ends of the inclined rails are aligned with the inside of the elastic sheet (210), so that the electrical product assembly (1) is driven to be inserted into the elastic sheet (210).

4. The electrical intelligent concealed box structure device according to claim 2, wherein a wiring frame (206) sleeves a top of the elastic sheet (210); and an outer wall of one side of the wiring frame (206) away from the safety door (204) is clamped with several fixing screws (209) to drive the safety door (204) to keep being connected and fixed with the elastic sheet (210).

5. The electrical intelligent concealed box structure device according to claim 1, wherein reset springs (205) are arranged at end portions of two opposite sides of the safety door (204); and the reset springs (205) are configured to drive the safety door (204) to keep sliding back and forth along the elastic sheet (210), so as to drive the elastic sheet (210) to be exposed.

6. The electrical intelligent concealed box structure device according to claim 4, wherein the concealed box assembly (2) comprises a concealed box bottom cover (207); several separation slots (208) of concealed box are formed in the concealed box bottom cover (207) to clamp the various fixing screws (209); and the concealed box bottom cover (207) is driven to be clamped to an outer wall of the concealed box inner slot (202), so as to drive the elastic sheet (210) and the safety door (204) to be accommodated in the concealed box shell (201).

7. The electrical intelligent concealed box structure device according to claim 1, wherein the electrical product assembly (1) comprises a product shell (101); several insertion sheets (102) are arranged in the product shell (101); and the insertion sheets (102) keep being electrically connected to the elastic sheet (210).
